(19) United States
(12) Patent Application Publication
(10) Pub. No.: US 2011/0242723 A1
(43) Pub. Date: Oct. 6, 2011

(54) RELAY DRIVER CIRCUIT

(75) Inventors: Daisuke Akita, Tokyo (JP); Yuuichi Kumazawa, Tokyo (JP)

(73) Assignee: YAMATAKE CORPORATION, Tokyo (JP)

(21) Appl. No.: 13/050,081

(22) Filed: Mar. 17, 2011

(30) Foreign Application Priority Data
Mar. 30, 2010 (JP) 2010-079486

(51) Int. Cl. H01H 47/18; H01H 47/22

(52) U.S. Cl. 361/186

(57) ABSTRACT

Power that is supplied to a primary coil of a transformer from a DC power supply that is connected to the primary coil is modulated based on continuous pulses supplied from a microcontroller, and power that is induced between terminals of a secondary coil of the transformer is supplied to a relay. A large driving current can be supplied to the relay thereby, thus making it possible to reduce the ripple component, and, as a result, to achieve stabilized operation.

### CROSS REFERENCE TO RELATED APPLICATIONS

The present application claims priority under 35 U.S.C. § 119 to Japanese Patent Application No. 2010-079486, filed Mar. 30, 2010, which is incorporated herein by reference.

### FIELD OF TECHNOLOGY

The present invention relates to a relay driving circuit for driving an electromagnetic relay.

### BACKGROUND OF THE INVENTION

Electromagnetic relays are used more often than semiconductor relays for safety relays in combustion furnaces. This is because the ability to withstand noise and the ability to withstand the environment, which are the distinctive features of the electromagnetic relay, are more important than rapid response time and long service life, which are the distinctive features of semiconductor relays. Conventionally, circuits that use capacitors, as illustrated in FIG. 5 and FIG. 6, have been used as circuits for driving electromagnetic relays safely (See, for example, Unexamined Japanese Patent Application Publication 1108-145355).

In the circuit illustrated in FIG. 5, only during the interval wherein a pulse signal, provided from a microcomputer, is provided is the relay ON, that is, when the pulse signal is at the high level, then the transistor Q1 goes into the ON state, and an electric current flows in the capacitors C2 and C1, to cause the voltage between the base and the emitter of the transistor Q2 to be higher than a specific level, to cause the transistor Q2 to go into the ON state, to apply a DC current to the coil of the relay. When that pulse signal goes to the low level, then the transistor Q1 goes into the OFF state, and the capacitor C1 discharges, and the capacitor C2 discharges through the emitter and base, where the transistor Q2 maintains the ON state through the discharged electric charge. Following this, prior to the transistor Q2 going into the OFF state, the pulse signal switches to the high level, and while the pulse signal repetitively switches between the high level and the low level, at a specific frequency, the transistor Q2 will always maintain the ON state, to apply the DC current to the coil of the relay.

Even in the circuit illustrated in FIG. 6, the relay can be turned ON only during the interval wherein a pulse signal is provided. In the circuit illustrated in FIG. 6, the power supply Vcc is supplied from the right end in the figure and a controlling portion (not shown) is connected to drive either the transistor Q3 or the transistor Q4 on the left end in the figure. This controlling portion may be structured from, for example, a transistor, a microcontroller, or a driver having such functions. The transistors Q3 and Q4 may be switched ON/OFF by switching the voltage at the contact point between the controlling portion in the circuit illustrated in FIG. 6 to the high level or the low level. That is, it is possible to produce a high-level/low level pulse signal at the circuit in FIG. 6 by discontinuously switching the high level/low level of the controlling portion. When the pulse signal here is at the high level, the transistor Q3 goes into the ON state, and the electric current flowing through the contact point “a” and the Resistor R7 arrives at the contact point c through the transistor Q3, and ultimately arrives at the contact point “e” through the diode D2, the contact point “d,” the capacitor C3, and the Resistor R8. Doing so causes the capacitor C3 to charge. When the pulse signal is at the low level, the transistor Q3 will go into the OFF state, and the transistor Q4 will go into the ON state. Doing so causes the capacitor C3 to discharge, where this electric current arrives at the contact point “f” through the contact point “d” and the diode D3, and after passing through the capacitor C4, the Resistor R9, and the relay, arrives at the transistor Q4 through the contact point “c.” This supplies the electric current to the capacitor C4 and the relay, thereby not only charging the capacitor C4, but also causing the relay to go into the ON state. When the pulse signal again goes to the high level, then, as described above, not only is the capacitor C3 charged, but the capacitor C4 is discharged. The current from the capacitor C4 flows through the contact point “f,” the relay, and the Resistor R9, to the capacitor C4. This supplies an electric current to the relay, causing the relay to go into the ON state. In this way, over the interval in which the pulse signal is iterating between the high-level and the low level at a specific period, the capacitors C3 and C4 are alternatingly charged and discharged, and a DC electric current is supplied continuously to the relay, maintaining the relay in the ON state.

A distinctive feature of these circuits is that they are able to circumvent danger, by turning the relay OFF, if there is a failure in any of the components included in the circuit. For example, in order to maintain the relay in the ON state, continuous pulses must be supplied from the microcontroller, and if the supply of the pulses were to stop due to a failure in the microcontroller, the relay would be turned OFF. The design is such that the relay will reliably turn OFF if there is a failure in any other component as well.

However, in the circuit illustrated in FIG. 6, the ripple component of the voltage between the relay terminals is large due to the use of only the electric power stored in the capacitor as the driving power supply for the relay, making it difficult to satisfy ripple voltage tolerance specifications for the relay, causing the operation to be unstable.

Additionally, in the circuit illustrated in FIG. 5, it is necessary to provide electric power to both the capacitors C1 and C2 when turning the transistor Q2 ON, thus requiring extra electric power beyond the power supplied to the electromagnetic relay, resulting in a problem in that the power efficiency (the ratio of the output power to the input power) is poor.

Given this, the object of the present invention is to provide a relay driving circuit able to achieve stabilized operations.

### SUMMARY OF THE INVENTION

In order to achieve an object such as set forth above, the relay driving circuit according to the present invention includes a transformer; a direct-current (DC) power supply that is connected to the primary coil of the transformer; a modulating circuit for modulating, based on a control signal from the outside, the power supplied to the first coil of the transformer from the DC power supply; and a supplying circuit for supplying, to an electromagnetic relay that is provided with a mechanical contact point, electric power induced between the terminals of a secondary coil of the transformer.

In the relay driving circuit set forth above, the modulating circuit may be structured from a switching element, that is turned ON/OFF by a pulse circuit, connected in series with the primary coil of the transformer and with the DC power supply.

Additionally, in the relay driving circuit set forth above, the providing circuit may be further provided with a rectifying circuit for rectifying the voltage produced between the terminals of the secondary coil and providing this voltage to the electromagnetic relay.

The present invention is able to achieve stabilized operation as a result of reducing the ripple component in the voltage between the relay terminals due to the ability to provide an adequate relay driving current through modulating, based on a control signal from the outside, the power that is supplied to the primary coil of a transformer, from a DC power supply that is connected to the DC power supply, and the power that is induced between the terminals of the secondary coil of the transformer is supplied to an electromagnetic relay that is provided with a mechanical contact point.

Furthermore, it is possible to increase the power efficiency through the ability to provide power to the relay without charging/discharging the capacitors by turning the transistor ON/OFF based on a control signal. Since the power is supplied to the relay by a transformer through modulating, based the control signal, the power that is supplied to the primary coil of the transformer is all that is required.

Moreover, the double isolation between the device that is being driven using the relay (the load) and the DC power supply, through the use of the transformer and the electromagnetic relay, makes it possible to minimize the effects on the DC power supply side even if a fault were to occur in the load, resulting in the ability to provide a stabilized circuit.

### BRIEF DESCRIPTION OF THE DRAWINGS

FIG. 1 is a circuit diagram illustrating the structure of a relay driving circuit according to the present invention.

FIG. 2A is a diagram illustrating the voltage waveform of the input pulse of a relay driving circuit according to the present invention.

FIG. 2B is a diagram illustrating the voltage waveform of the transformer in a relay driving circuit according to the present invention.

FIG. 2C is a diagram illustrating the driving voltage waveform for the relay in a relay driving circuit according to the present invention.

FIG. 3 is a diagram illustrating an example of a driving voltage waveform for the relay in a conventional relay driving circuit.

FIG. 4 is a diagram illustrating an example of a driving voltage waveform for the relay in a relay driving circuit according to the present invention.

FIG. 5 is a circuit diagram illustrating the structure of a conventional relay driving circuit.

FIG. 6 is a circuit diagram illustrating the structure of a second conventional relay driving circuit.

### DETAILED DESCRIPTION OF INVENTION

Forms exemplifying the present invention are explained in detail below in reference to the drawings.

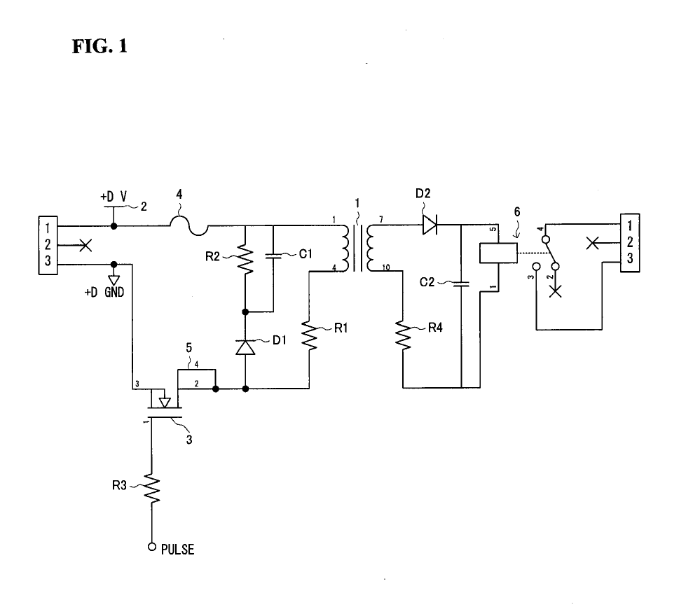

As illustrated in FIG. 1, the relay driving circuit according to an example of the present invention has a transformer 1; a circuit (primary-side circuit) that is connected to the primary-side coil of the transformer 1; and a circuit (secondary-side circuit) that is connected to the secondary side coil of the transformer 1.

A DC power supply 2 is connected in series with the primary-side circuit. Additionally, a switching element 3, a fuse 4, a feedback circuit 5, and a resistor R1 are connected in series between the transformer 1 and the DC power supply 2, and a diode D1, and a resistor R2 and a capacitor C1, which are each connected in series with the diode D1, are connected in parallel between the transformer 1 and the DC power supply 2. A pulse signal from a microcontroller is inputted into the switching element 3 through a resistance R3.

In the secondary-side circuit, a relay 6 is connected in series, through a diode D2 for rectification on one end, and through a resistor R4 on the other end. In addition, a smoothing capacitor C2 is connected in parallel between the transformer 1 and the relay 6. Here the diode D2 and the smoothing capacitor C2 structure a rectifying circuit. The rectifying circuit has a function of applying, to the relay 6, a virtual DC current by regulating, to a constant voltage, the terminal voltage applied from the secondary side of the transformer 1 to the relay 6. If this rectifying circuit were not provided, then the pulse voltage, converted by the switching element 3, would be inputted directly into the relay 6, and while it would be possible to perform an operation wherein the relay would be turned ON/OFF continuously and repetitively if the pulse voltage were at a relatively low frequency, if the frequency were relatively high, then the electric current required for driving the relay 6 could not be applied during the entire cycle, so there would be the risk that the relay 6 would be stuck in the OFF state.

The operation of the relay driving circuit of this type of structure is explained next.

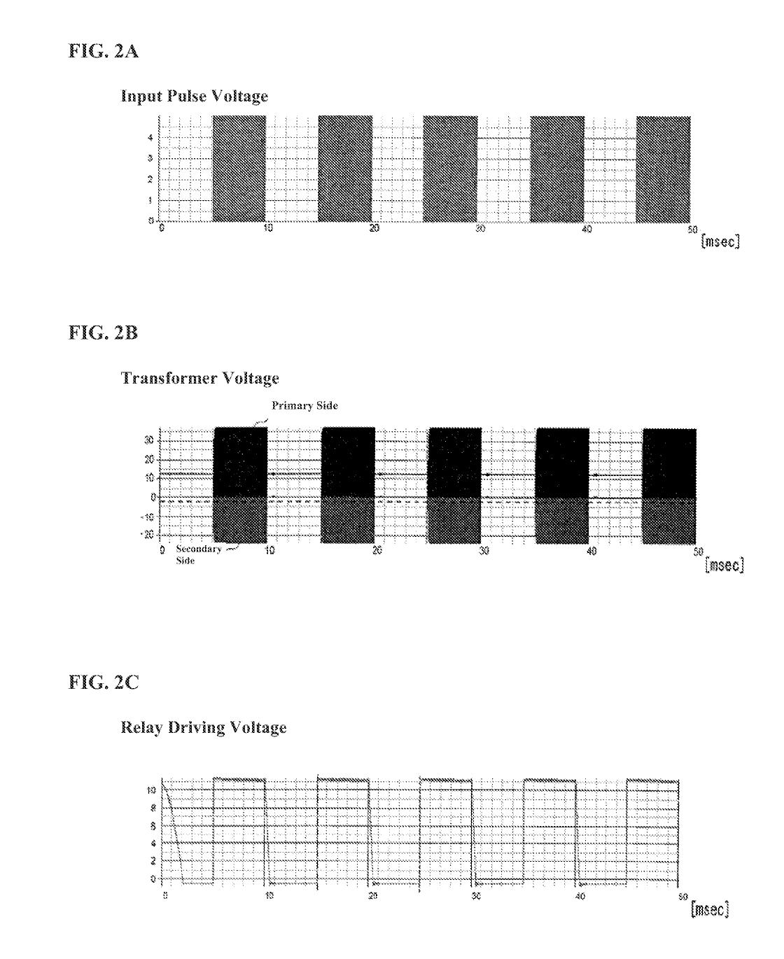

The switching element 3 repetitively turning ON/OFF when the continuous pulse is inputted from the microcontroller (not shown) causes the DC voltage, which is supplied from the DC power supply 2, to be converted into a pulse voltage that is synchronized with the continuous pulses, as illustrated in FIG. 2A.

The converted pulse voltage passes through the transformer 1 to propagate from the primary side to the secondary side thereof. At this time, the transformer 1, as illustrated in FIG. 2B, transmits the pulse voltage from the primary side to the secondary side.

The pulse voltage that is transmitted to the secondary side of the transformer 1 is again converted into a DC voltage, as illustrated in FIG. 2C, through the rectifying diode D2 and the smoothing capacitor C2. This DC voltage is the driving voltage for the relay 6, so the relay 6 will be in the ON state while pulses are supplied from the microcontroller, and the relay 6 will go into the OFF state when the supply of pulses is stopped.

If there is a failure in the microcontroller, the switching element, or the like, so that the pulses are not inputted continuously, then, in the present example, the driving voltage ceases to be supplied to the relay 6 in the secondary-side circuit. For example, if, due to a failure, there were a situation wherein only the low-level or high-level voltage were supplied to the transformer 1 from the primary-side circuit, then the power supply that is connected to the primary-side circuit would be the DC power supply 2, and thus the electric current in the secondary-side circuit would stop. In this way, in the present example, the supply of the driving voltage to the relay 6 in the secondary-side circuit, and, by extension, the operation of the relay 6, can be prevented when a fault occurs, and thus there is excellent safety.

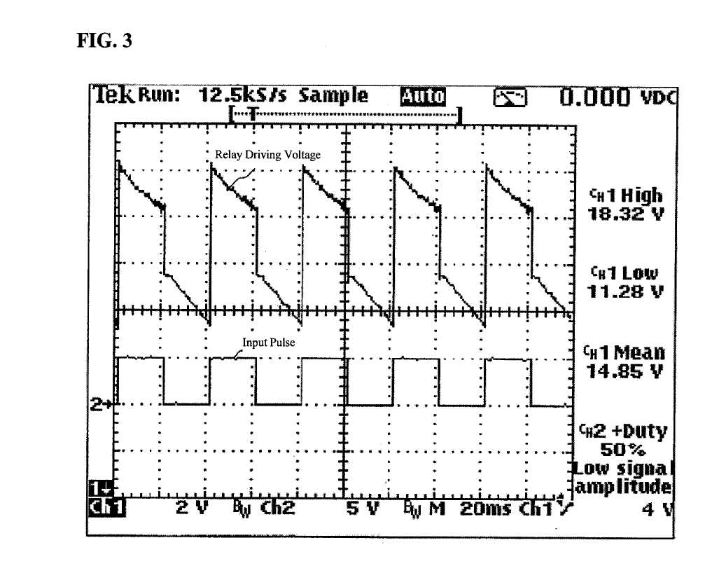

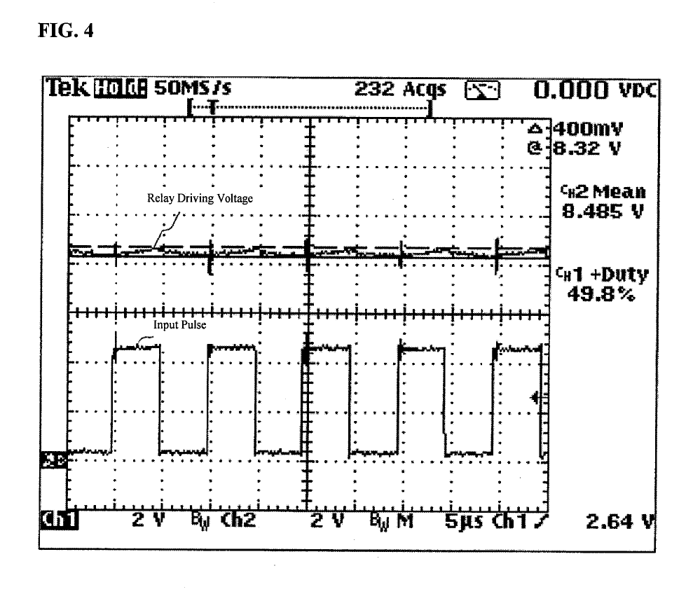

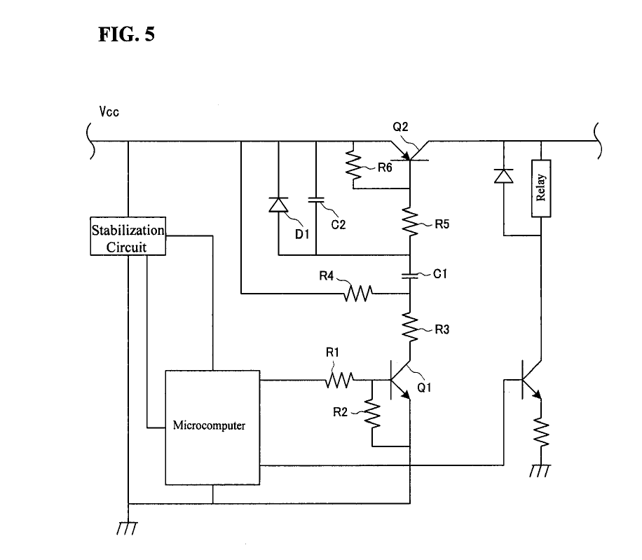

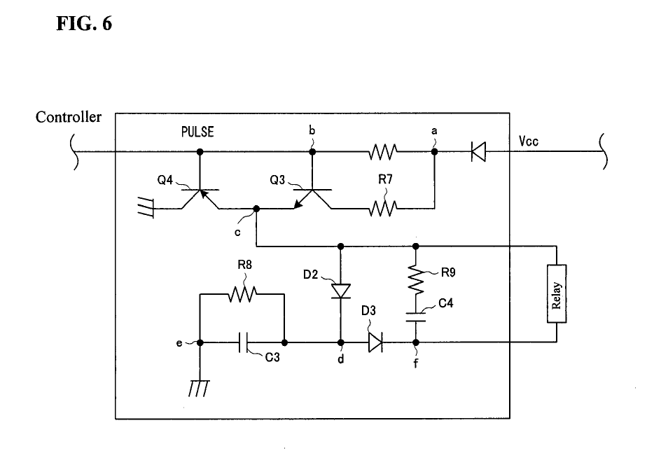

Here, when comparing with the conventional relay driving circuit, in the conventional relay driving circuit only the power stored in the capacitor was used as the driving power supply for the relay, and thus, as illustrated in FIG. 3, the ripple component was large in the relay driving voltage. In the case in FIG. 3, the ripple component was about 7V. In contrast, in the present example, the power that is stored in the inductor of the transformer 1 and in the capacitor can be supplied to the relay 6, and thus, as illustrated in FIG. 2C and FIG. 4, the size of the ripple component can be reduced. In the case in FIG. 4, the ripple component goes to 400 mV. Note that in the present form of embodiment, the duty ratio can be controlled to control the shape of the voltage ripple as well.

Additionally, in the present example, as explained above, it is possible to provide, to the relay 6, the power that is stored in the inductor of the transformer 1 and in the capacitor, so that the driving current of the relay 6 is not controlled by the capacitance of the capacitor, thus making it possible to supply a large driving current to the relay 6, which reduces the ripple component in the voltage between the terminals of the relay 6, which, as a result, makes it possible to perform stabilized controlled. Furthermore, it is possible to increase the power efficiency through the ability to provide power to the relay 6 without charging/discharging the capacitor by turning the transistor ON/OFF based on a control signal, because the power is supplied to the relay 6 by a transformer 1 through modulating, based the control signal, the power that is supplied to the primary coil of the transformer 1.

Additionally, in the example, the provision of the transformer 1 isolates the primary side circuit, to which the microcontroller is connected, from the secondary-side circuit, to which they relay 6 is connected, thus making it possible to prevent the propagation of noise to the microcontroller side, which, as a result, makes it possible to perform stabilized controlled. That is, because there is double isolation between the microcontroller and the load, there is enhanced safety when a fault occurs, such as a short in the load. Furthermore, because the power supply is produced locally, there is no need for a driving power supply for the relay 6, making it possible to provide power also to circuitry other than the relay 6, such as for failure diagnostics. Above all, there is no need to use an electrolytic capacitor, or the like, as the driving power supply for the relay 6 when the power capacity of the relay 6 is small, which means that the service life of the circuit will not be dependent on the service life of the electrolytic capacitor which, as a result, can increase the service life of the circuit.

Additionally, the present example makes it possible to set the driving voltage for the relay 6 by controlling the switching frequency or duty ratio, enabling selection from a variety of relays. That is, it is necessary to use a switching element 3 or a DC/AC converter to cause the electric current that is supplied to the primary side of the transformer 1 to be a pulsed current or an AC current in order to drive the transformer 1 when using a DC power supply such as in the present example, or in other words, it is necessary to perform modulation. However, it is possible to change the voltage that is supplied by the secondary side of the transformer 1 to the relay 6, through using a modulating circuit to set, as appropriate, the electric current waveform that is supplied to the primary side of the transformer 1.

Additionally, the transformer 1 may be such that a voltage that is larger than the input voltage on the primary side is outputted, as the secondary side voltage, to the relay 6 (that is, the voltage may be stepped up). Conventionally, it has been necessary to select and use a relay that depends on the supply voltage. However, in the present example a supply voltage that is suitable to the relay is produced through the settings for the switching element 3 and the transformer 1, enabling the design of the circuit to be performed more easily.

Furthermore, in the present example, voltage regulation control can be performed through feeding back the output voltage to the microcontroller, to achieve stabilized relay control and diagnostics.

The present invention can be applied to a variety of devices that are provided with electromagnetic relays.

Scope of patent claims

1. A relay driving circuit comprising:
a transformer;
a DC power supply connected to a primary coil of the transformer;
a modulating circuit for modulating, based on a control signal from the outside, voltage supplied to the primary coil of the transformer from the DC power supply; and
a supplying circuit for supplying power that is induced between the terminals of a secondary coil of the transformer to an electromagnetic relay that is provided with a mechanical contact point.

2. A relay driving circuit as set forth in claim 1, wherein:
the modulating circuit is structured from a switching element that is turned ON/OFF by a pulse signal, connected in series with the primary coil of the transformer and with the DC power supply.

3. A relay driving circuit according to claim 1, wherein:
the supplying circuit further comprises a rectifying circuit rectifying and supplying to the electromagnetic relay, power produced between the terminals of the secondary coil.
